(19) United States
(12) Patent Application Publication
(10) Pub. No.: US 2025/0365669 A1
(43) Pub. Date: Nov. 27, 2025

(54) TRANSMISSION PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Lihui WANG, Dongguan (CN); Xin QU, Dongguan (CN)

(73) Assignee: VIVO MOBILE COMMUNICATION CO., LTD., Dongguan (CN)

(21) Appl. No.: 19/295,547

(22) Filed: Aug. 8, 2025

Related U.S. Application Data
(63) Continuation of application No. PCT/CN2024/075366, filed on Feb. 2, 2024.

(30) Foreign Application Priority Data
Feb. 9, 2023 (CN) 202310089271.8

(51) Int. Cl. H04W 52/02

(52) U.S. Cl. CPC H04W 52/0235; H04W 52/0274

(57) ABSTRACT

This application discloses a transmission processing method and apparatus, a terminal, and a network side device, and belongs to the field of communication technologies. The transmission processing method in the embodiments of this application includes: performing, by a terminal, a target operation when there is a conflict between transmission of first information and transmission of second information, where the first information includes at least one of a wake up signal, the second information includes at least one of a physical channel and a signal, and the target operation includes transmitting the second information without transmitting a part of the first information whose transmission conflicts with the transmission of the second information.

### CROSS-REFERENCE TO RELATED APPLICATIONS

This application is a bypass continuation of International Application No. PCT/CN2024/075366, filed Feb. 2, 2024, which claims priority to Chinese Patent Application No. 202310089271.8, filed on Feb. 9, 2023 in China. The entire contents of the above-referenced applications are expressly incorporated herein by reference in their entirety.

### TECHNICAL FIELD

This application belongs to the field of communication technologies, and in particular, to a transmission processing method and apparatus, a terminal, and a network side device.

### BACKGROUND

With the development of communication technology, a low power wake up signal (LP-WUS) is received by introducing a low power wake up receiver (LP-WUR) in a mobile communication terminal, so that a main communication module is in an off or sleep state, and power consumption of the terminal can be effectively reduced. Due to the introduction of additional LP-WUR, the terminal side may transmit channels or signals thereof by using two receivers, which may cause a conflict between channels or signals transmitted by different receivers, resulting in low communication reliability.

### SUMMARY

Embodiments of this application provide a transmission processing method and apparatus, a terminal, and a network side device, which can solve the problem that a conflict between different channels or signals results in low communication reliability.

According to a first aspect, a transmission processing method is provided, including:
performing, by a terminal, a target operation in a case that there is a conflict between transmission of first information and transmission of second information, where
the first information includes at least one of a wake up signal, backscatter transmission information, and a beacon signal, the second information includes at least one of a physical channel and a signal, and the target operation includes any one of the following: transmitting the first information; and transmitting the second information.

According to a second aspect, a transmission processing method is provided, including:
sending, by a terminal, capability information to a network side device, where the capability information is used for determine a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:

whether to support the transmission based on a low power receiver and a main communication module at the same time; and
whether to support the transmission based on the low power receiver and the main communication module at the same frequency.

According to a third aspect, a transmission processing method is provided, including:
receiving, by a network side device, capability information from a terminal; and
determining, by the network side device based on the capability information, a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

According to a fourth aspect, a transmission processing apparatus is provided, including:
an execution module, configured to perform a target operation in a case that there is a conflict between transmission of first information and transmission of second information, where
the first information includes at least one of a wake up signal, backscatter transmission information, and a beacon signal, the second information includes at least one of a physical channel and a signal, and the target operation includes any one of the following: transmitting the first information; and transmitting the second information.

According to a fifth aspect, a transmission processing apparatus is provided, including:
a first sending module, configured to send capability information to a network side device, where the capability information is used for determine a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

According to a sixth aspect, a transmission processing apparatus is provided, including:
a receiving module, configured to receive capability information from a terminal; and
a determining module, configured to determine, based on the capability information, a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

According to a seventh aspect, a terminal is provided. The terminal includes a processor and a memory, the memory stores a program or an instruction that can be run on the processor, and when the program or the instruction is executed by the processor, the steps of the method according to the first aspect or the steps of the method according to the second aspect are implemented.

According to an eighth aspect, a terminal is provided, including a processor and a communication interface, where the communication interface is configured to perform a target operation in a case that there is a conflict between transmission of first information and transmission of second information, where the first information includes at least one of a wake up signal, backscatter transmission information, and a beacon signal, the second information includes at least one of a physical channel and a signal, and the target operation includes any one of the following: transmitting the first information; and transmitting the second information; or
the communication interface is configured to send capability information to a network side device, where the capability information is used for determine a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

According to a ninth aspect, a network side device is provided. The network side device includes a processor and a memory, the memory stores a program or an instruction that can be run on the processor, and the program or the instruction is executed by the processor to implement the steps of the method according to the third aspect.

According to a tenth aspect, a network side device is provided, including a processor and a communication interface. The communication interface is configured to receive capability information from a terminal; and the processor is configured to determine, based on the capability information, a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

According to an eleventh aspect, a communication system is provided, including a terminal and a network side device. The terminal may be configured to perform the steps of the transmission processing method according to the first aspect or the second aspect, and the network side device may be configured to perform the steps of the transmission processing method according to the third aspect.

According to a twelfth aspect, a readable storage medium is provided. The readable storage medium stores a program or an instruction. When the program or the instruction is executed by a processor, the steps of the method according to the first aspect are implemented, the steps of the method according to the second aspect are implemented, or the steps of the method according to the third aspect are implemented.

According to a thirteenth aspect, a chip is provided. The chip includes a processor and a communication interface. The communication interface is coupled to the processor. The processor is configured to run a program or an instruction, to implement the steps of the method according to the first aspect, the steps of the method according to the second aspect, or the steps of the method according to the third aspect.

According to a fourteenth aspect, a computer program/program product is provided. The computer program/program product is stored in a storage medium, and the computer program/program product is executed by at least one processor to implement the steps of the method according to the first aspect, the steps of the method according to the second aspect, or the steps of the method according to the third aspect.

In the embodiments of this application, the terminal performs the target operation in a case that there is a conflict between transmission of the first information and transmission of the second information; and the target operation includes any one of the following: transmitting the first information; and transmitting the second information. In this way, it is clear that when there is a conflict between the first information and the second information, a terminal behavior is to transmit the first information or transmit the second information. The embodiments of this application provide a conflict resolution solution, to ensure that the terminal and the network side device have the same understanding of the terminal behavior after the conflict, and improve reliability of communication.

### BRIEF DESCRIPTION OF DRAWINGS

FIG. 1 is a schematic diagram of a network structure to which the embodiments of this application can be applied;

FIG. 2 is a schematic flowchart of a transmission processing method according to an embodiment of this application;

FIG. 3 is an example diagram of a transmission conflict scenario in a transmission processing method according to an embodiment of this application;

FIG. 4 is an example diagram of transmission of a beacon signal in a transmission processing method according to an embodiment of this application;

FIG. 5 is a schematic flowchart of another transmission processing method according to an embodiment of this application;

FIG. 6 is a schematic flowchart of still another transmission processing method according to an embodiment of this application;

FIG. 7 is a schematic diagram of a structure of a transmission processing apparatus according to an embodiment of this application;

FIG. 8 is a schematic diagram of a structure of another transmission processing apparatus according to an embodiment of this application;

FIG. 9 is a schematic diagram of a structure of still another transmission processing apparatus according to an embodiment of this application;

FIG. 10 is a schematic diagram of a structure of a communication device according to an embodiment of this application;

FIG. 11 is a schematic diagram of a structure of a terminal according to an embodiment of this application; and

FIG. 12 is a schematic diagram of a structure of a network side device according to an embodiment of this application.

### DETAILED DESCRIPTION

The following clearly describes technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. In addition, objects distinguished by “first” and “second” are generally of a same type, and the number of objects is not limited, for example, there may be one or more first objects. In addition, in this specification and the claims, “or” represents at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in the specification and claims of this application may be either an explicit indication or an implicit indication. The explicit indication can be understood as that a sender clearly informs a receiver of an operation required to be performed or a request result in a sent indication; and the implicit indication can be understood as that the receiver makes a determination based on an indication sent by the sender, and determines the operation required to be performed or the request result based on a determination result.

It should be noted that technologies described in the embodiments of this application are not limited to a Long Term Evolution (Long Term Evolution, LTE)/LTE-Advanced (LTE-Advanced, LTE-A) system, and may be further applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), Single-carrier Frequency Division Multiple Access (Single-carrier Frequency Division Multiple Access, SC-FDMA), and other systems. The terms “system” and “network” in the embodiments of this application may be used interchangeably. The described technologies can be applied to both the systems and the radio technologies mentioned above as well as to other systems and radio technologies. The following descriptions describe a new radio (New Radio, NR) system for example purposes, and NR terms are used in most of the following descriptions, but these technologies can also be applied to an application other than an NR system application, for example, a 6^{th} generation (6^{th} Generation, 6G) communication system.

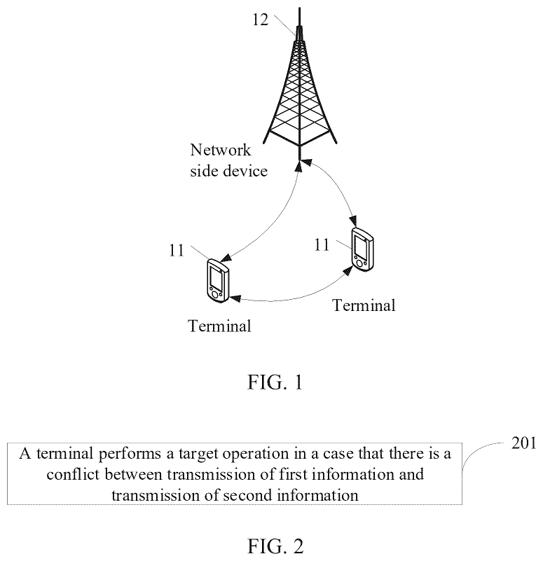

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (UMPC), a mobile Internet device (MID), an augmented reality (AR)/virtual reality (VR) device, a robot, a wearable device (Wearable Device), vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart bangle, a smart anklet, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a wireless fidelity (Wi-Fi) node, or the like. The base station may be referred to as a NodeB, an evolved NodeB (eNB), an access point, a base transceiver station (BTS), a radio base station, a radio transceiver, a basic service set (Basic Service Set, BSS), an extended service set (ESS), a home NodeB, a home evolved NodeB, a transmission reception point (TRP), or another appropriate term in the field. As long as a same technical effect is achieved, the base station is not limited to a specified technical term. It should be noted that, in this application, only a base station in an NR system is used as an example, and a specific type of the base station is not limited.

To facilitate understanding, some content involved in the embodiments of this application is described below.

### I. Low Power Receiver

The low power receiver can also be referred to as an LP-WUR or almost zero power wake up receiver (almost zero power wake up receiver, AZP-WUR). A basic working principle of the LP-WUR is: a receive end includes a first module and a second module, the first module is a main communication module (can also be referred to as a main receiver (Main receiver, MR) module), configured to send and receive mobile communication data, and the second module is a low power receiving module (also referred to as a low power wake up receiving module), configured to receive the wake up signal (or referred to as a low power wake up signal). In an energy-saving state, the terminal enables the low power receiving module to monitor the LP-WUS and disables the main communication module. When downlink data arrives, the network side device may send a wake up signal to the terminal. After monitoring the wake up signal by using the low power receiving module, the terminal triggers the main communication module to switch from being disabled to being enabled through a series of determinations. In this case, the low power receiving module enters a disabled state from a working state. The low power wake up receiving module may be enabled continuously or intermittently, and may receive the wake up signal when being enabled.

### II. Low Power Wake Up Signal (LP-WUS)

To reduce receiving activities of the terminal in a standby state, and enable radio frequency (RF) and baseband (also referred to as Modem) modules to be actually disabled, thereby greatly reducing power consumption of communication reception, an almost “zero” power receiver may be introduced into the receiving module of the terminal. This almost “zero” power receiver does not need complex RF module signal detection (such as amplification, filtering, quantization, and the like) and Modem signal processing, and relies on only passively matching filtering and signal processing with lower power consumption.

On a base station side, the low power wake up signal is triggered on-demand (on-demand), so that the almost “zero” power receiver may be activated to get an activation notice, to trigger a series of processes inside the terminal, for example, enabling modules such as radio frequency transceiver and baseband processing.

These low power wake up signals are usually some simple on-off keying (on-off keying) signals. In this way, the receiver may learn of a wake up notice through simple energy detection, subsequent possible sequence detection and identification, and other processes. In addition, when the terminal enables the low power wake up receiver to receive the low power wake up signal, a main receiver module may operate at a lower power consumption level, thereby reducing power consumption by receiving the low power wake up signal.

### III. Beacon (Beacon) Signal

The beacon signal is a periodically sent signal for conveying time information. The receive end may obtain time synchronization information by receiving the beacon signal. In some embodiments, alternatively, mobility measurement, channel measurement, or the like may be performed by receiving the beacon signal. Both the beacon and the LP-WUS are received by the low power receiver. In an embodiment, the beacon can be regarded as a downlink synchronization signal for LP-WUS reception. In another embodiment, the beacon signal can also be used for terminal mobility measurement, such as cell selection, cell reselection, or other functions. In addition, optionally, there may be a correlation between a beacon signal sequence and an LP-WUS sequence. For example, the beacon signal sequence is a part of the LP-WUS sequence.

In a related protocol, the beacon signal is transmitted by using a specific medium access control (MAC) frame (frame). A type dependent control (Type dependent control) field of the WUR beacon MAC frame carries a time synchronization function (TSF) of an access point (AP). After receiving an information bit corresponding to the function, a user updates a local TSF clock according to the time update criteria defined by 802.11ba, to achieve the purpose of synchronization with the AP. An offset between a sending cycle of the WUR beacon and a sending start location is indicated by an operation element (operation element) sent by the AP. When carrier sense multiple access (CSMA) deferrals (deferrals) occur, the WUR beacon may be postponed to be sent in a current circle, but is still sent in a subsequent circle based on the sending circle of the WUR beacon and a location determined based on the sending start location.

### IV. A Monitoring Cycle of a Beacon Signal and a Wake Up Signal (WUS)

Beacon and LP-WUS monitoring configuration methods are as follows.
1. In LP-WUS monitoring duration of each LP-WUS monitoring cycle, the terminal performs measurement and synchronization based on beacon and detects the LP-WUS. A beacon measurement cycle is greater than or equal to an LP-WUS monitoring cycle.
2. Beacon monitoring is not associated with LP-WUS monitoring. That is, the beacon cycle and the LP-WUS monitoring cycle can be different in size and monitoring duration.

### V. SS/PBCH Block Measurement Timing Configuration (SMTC)

The purpose of SMTC is to configure when user equipment (User Equipment, UE) performs RRM measurement. The SMTC is used for synchronization signal and PBCH block (SSB) measurement configuration of radio resource management (Radio resource management, RRM) or radio link monitoring (RLM) measurement. The UE does not perform any RRM measurement based on the SSB and a channel state information reference signal (CSI-RS) on an SSB other than the SMTC.

The SMTC mainly includes the following configuration parameters: a cycle, an offset, and a duration window size of the RRM measurement based on the SSB in each cycle.

### VI. Backscatter Communication (Backscatter Communication, BSC) or Passive Internet of Things (passive IoT) Communication

Backscatter communication means that a backscatter communication device performs signal modulation by using a radio frequency signal in another device or an environment to transmit information.

The backscatter communication device may be:
(1) a backscatter communication device in conventional radio frequency identification (Radio Frequency Identification, RFID), which is usually a tag (Tag), and belongs to a passive-IoT (Passive-IoT) device;
(2) a semi-passive (semi-passive) tag, where this type of tag has a specific amplification ability for downlink reception or uplink reflection; and
(3) a tag with an active sending capability (active tag), where this type of terminal may send information to a base station (gNB) or a reader (reader) without relying on the reflection of the incident signal.

A simple implementation is: a tag reflects an incident carrier signal when the tag needs to send ‘1’, and does not reflect the incident carrier signal when the tag needs to send ‘0’.

The backscatter communication device controls a reflection coefficient of a circuit by adjusting internal impedance of the backscatter communication device, to change an amplitude, a frequency, a phase, and the like of an incident signal, thereby implementing signal modulation. A reflection coefficient of a signal may be represented as:

$$Γ = \frac{{Z}_{1} - {Z}_{0}}{{Z}_{1} + {Z}_{0}} = \vert Γ \vert {e}^{j {θ}_{𝒯}} ,$$

where

Z₀ is antenna characteristic impedance, and Z₁ is load impedance. It is assumed that the incident signal is Sᵢₙ(t). In this case, an output signal is Sₒᵤₜ(t)=Sᵢₙ(t)|Γ|e^{jθ}^{_{T}}. Therefore, corresponding amplitude modulation, frequency modulation, or phase modulation can be implemented through proper control of the reflection coefficient.

Optionally, in this embodiment of this application, the tag device is the backscatter communication device.

Optionally, in this embodiment of this application, first transmission may be related transmission in backscatter communication.

In this embodiment, the backscatter communication includes transmission of the following signals, that is, backscatter transmission information includes at least one of the following.
(1) Continuous wave (CW) transmission is continuous wave transmission; and in an embodiment, the excitation wave may be sent to a tag (tag) by a network side device, or may be sent to the tag by a terminal.
(2) Control command (command) transmission, for example, a select command, a query command, a repeat query command, a reply command, a read command, a write command, a random request command, and the like; and in an embodiment, the control command may be sent to a tag (tag) by a network side device, or may be sent to the tag by a terminal.

Optionally, the control command may include at least one of the following: a select type command, a query type command, and an access command; the select type command includes at least one of the following: a select command (a specific select command), an inventory command, and a sorting command; the query type command includes at least one of the following: a query command (a specific query command), an adjustment query command, and a repeat query command; and the access command includes at least one of the following: a random request command, a read command, a write command, a destroy command, a lock command, an access command, a security-related access command, and a file management-related access command.

The select type (Select) command is necessary. Because tags have many attributes, the select type command is used based on standards and strategies set by the user, and a specific tag group is selected or delineated artificially by changing some attributes and marks. Only inventory identification or access operations can be performed on the tag group, which is conducive to reducing conflicts and duplicate identification and accelerating an identification speed.

A command in an inventory stage is used to start an inventory. For example, the query command is used to start a round of inventory and decide which marks participate in this round of inventory; the adjustment query command is used to adjust a quantity of original receiving slots (Slot) of the tag; and the repeat query command is used to reduce the number of a tag Slot.

In the access command (Access), the random request (Req_RN) command requires the tag to generate a random number; the read command is used to read data from a location in the storage of the tag; the write command is used to write data into the storage of the tag; the destroy command can be leaked in privacy, and the tag can no longer be used; the lock command is used when the tag can no longer write, to prevent the data from being arbitrarily tampered with; the access command is used to switch the tag from an open (Open) state to a secure (Secure) state when the tag has a password; the security-related access command is used to ensure tag security; and the file management-related access command may be used to manage files within the tag.
(3) Feedback information transmission, which can also be understood as transmission of backscatter information in backscatter communication, including, for example, tag identification information (such as 16-bit random number temporarily representing tag identity in an inquiry process), and electronic product code information (such as electronic product code (EPC), product code (Product Code, PC), extended protocol control (XPC), and the like). In an embodiment, the backscatter channel or signal may be sent by a tag to a terminal through backscatter, or may be sent by a tag to a network side device through backscatter.

### VII. Application Scenarios of Backscatter (Backscatter) Communication

The backscatter communication includes the following application scenarios.
(1) A network side device sends CW and signaling and receives a reflected signal of a tag.
(2) A terminal sends CW and signaling and receives a reflected signal of a tag.
(3) A network side device sends CW and signaling to a tag; and a terminal receives backscatter information sent by the tag.
(4) A terminal sends CW and signaling to a tag; and a network side device receives backscatter information of the tag.

In this embodiment, types of the network side device, such as a base station, include but are not limited to: types of the base station include an integrated access and backhaul (Integrated Access and Backhaul, IAB) node (IAB node), a repeater (repeater) such as a network controlled repeater (network controlled repeater), and a pole station (pole station).

With reference to the accompanying drawings, a transmission processing method provided in the embodiments of this application is described in detail by using some embodiments and application scenarios thereof.

Referring to FIG. 2, an embodiment of this application provides a transmission processing method. As shown in FIG. 2, the transmission processing method includes the following steps.
Step 201: A terminal performs a target operation in a case that there is a conflict between transmission of first information and transmission of second information.

The first information includes at least one of a wake up signal, backscatter transmission information, and a beacon signal, the second information includes at least one of a physical channel and a signal, and the target operation includes any one of the following: transmitting the first information; and transmitting the second information.

In this embodiment of this application, the transmission can be understood as at least one of sending and receiving. For example, for the first information, that the terminal transmits the first information can be understood as that the terminal receives the first information. For the second information, that the terminal transmits the second information can be understood as: sending and/or receiving the second information.

It should be noted that in this embodiment of this application, that the target operation includes transmitting the first information can be understood as that the target operation includes not transmitting the second information (such as not receiving or not sending the second information). Not transmitting the second information can be understood as not transmitting the second information at a conflicting location. Further, not transmitting the second information further includes postponing transmitting the second information or transmitting the second information in a splitting manner, and giving up a part or all of transmission of the second information. Similarly, that the target operation includes transmitting the second information can be understood as that the target operation includes not transmitting the first information (such as not receiving the first information). The understanding of not transmitting the first information is the same as that of not transmitting the second information. Details are not described herein again.

Optionally, in some embodiments, receiving can be understood as giving priority to receiving, not receiving can be understood as at least one of the following:
postponing receiving, for example, the network side device may send conflicting information in a next or several cycles of a current receiving cycle, and correspondingly, the terminal may postpone receiving;
giving up receiving the whole information, for example, when receiving of an LP-WUS conflicts with receiving of an SSB, that the terminal does not receive the LP-WUS means that even if the LP-WUS overlaps with the SSB only in a small part, receiving of the whole LP-WUS is given up. It can be understood that giving up receiving of the whole LP-WUS refers to the conflicting LP-WUS, rather than giving up subsequent receiving of an LP-WUS; and
giving up receiving a part of the information, that is, giving up receiving information in a conflicting part.

Optionally, the wake up signal may be a low power wake up signal. The physical channel may include at least one of a physical uplink channel and a physical downlink channel, and may include, for example, all channels defined by NR. The signal may include all signals defined by NR.

In this embodiment of this application, the terminal performs the target operation in a case that there is a conflict between transmission of the first information and transmission of the second information; and the target operation includes any one of the following: transmitting the first information; and transmitting the second information. In this way, it is clear that when there is a conflict between the first information and the second information, a terminal behavior is to transmit the first information or transmit the second information. This embodiment of this application provides a conflict resolution solution, to ensure that the terminal and the network side device have the same understanding of the terminal behavior after the conflict, and improve reliability of communication.

Optionally, in some embodiments, that there is a conflict between transmission of first information and transmission of second information includes at least one of the following:
at least partially overlaps between a time domain location of the first information and a time domain location of the second information;
at least partially overlaps between a frequency domain location of the first information and a frequency domain location of the second information;
at least partially overlaps between a resource occupied by the actually transmitted first information and a resource occupied by the actually transmitted second information;
at least partially overlaps between a transmission window of the first information and a transmission window of the second information;
at least partially overlaps between a transmission window of the actually transmitted first information and a transmission window of the actually transmitted second information;
a time interval between the time domain location of the first information and the time domain location of the second information is smaller than a first time interval; and
a frequency domain interval between the frequency domain location of the first information and the frequency domain location of the second information is smaller than a first frequency domain interval.

Optionally, the transmission window can be understood as a transmission time window or a monitoring time window.

Furthermore, optionally, the time domain location of the first information includes a time domain location of a transmission time window of the first information. The time domain location of the second information also follows the same understanding.

In this embodiment of this application, the actually transmitted can be understood as that the terminal actually performs sending or receiving. In an embodiment, the network side device is configured with a periodic first information transmission occasions, but the terminal performs first information transmission on only some of the transmission occasions based on implementation. In this way, actually sent or received first information on the configured first information transmission occasions can be understood as being actually transmitted. It should be noted that overlap between transmission time windows or transmission occasions on which the terminal does not perform actual transmission does not belong to a conflict case.

Optionally, the first time interval includes at least one of a first transition latency and a second transition latency, where
the first transition latency is a transition latency for the terminal to switch from a reception behavior based on a low power receiver to a transmission behavior based on a main communication module, and the second transition latency includes a transition latency for the terminal to switch from the transmission behavior based on the main communication module to the reception behavior based on the low power receiver.

Optionally, the transition latency for the terminal to switch from the reception behavior based on the low power receiver to the transmission behavior based on the main communication module includes: a transition time from downlink receiving to uplink sending of the terminal; and the transition latency for the terminal to switch from the transmission behavior based on the main communication module to the reception behavior based on the low power receiver includes: a transition time from uplink sending to downlink receiving of the terminal.

Optionally, in some embodiments, the first information can be understood as information received by using the low power receiver, and the second information can be understood as information transmitted by using the main communication module. In other words, in this embodiment of this application, the transmitting the first information by the terminal includes: receiving, by the terminal, the first information based on a low power receiver; and the transmitting the second information by the terminal includes: transmitting, by the terminal, the second information based on the main communication module.

It should be noted that the low power wake up signal and the beacon signal are received based on the low power receiver.

Optionally, in some embodiments, before the performing, by a terminal, a target operation in a case that there is a conflict between transmission of first information and transmission of second information, the method further includes:
sending, by the terminal, capability information to a network side device, where
the capability information includes at least one of the following:
whether to support the transmission based on a low power receiver and a main communication module at the same time; and
whether to support the transmission based on the low power receiver and the main communication module at the same frequency.

In this embodiment of this application, because the terminal reports the capability information to the network side device, the network side device may determine, based on the capability information, whether the terminal supports transmission of the LP-WUR and the MR at the same time, and the network side device is assisted in determining a transmission behavior corresponding to the terminal when there is a conflict between the first information and the second information, to ensure that the terminal and the network side device have the same understanding of the terminal behavior after the conflict, and improve reliability of communication.

Optionally, the whether to support the transmission based on a low power receiver and a main communication module at the same time includes at least one of the following:
whether to support receiving based on both the low power receiver and the main communication module simultaneously; and
whether to support receiving based on the low power receiver and transmitting based on the main communication module simultaneously.

The receiving based on the low power receiver and receiving of the main communication module performed simultaneously can be understood as that the low power receiver and the main communication module may simultaneously receive downlink signals. The receiving based on the low power receiver and sending of the main communication module performed simultaneously can be understood as that the main communication module may send an uplink signal when the low power receiver receives a downlink signal.

Optionally, the whether to support receiving based on both the low power receiver and the main communication module simultaneously includes: whether to support receiving based on both the low power receiver and the main communication module simultaneously in a case that there isn't an overlap in frequency domain between the signal transmission based on the low power receiver and a signal transmission based on the main communication module; or
the whether to support receiving based on the low power receiver and transmitting based on the main communication module simultaneously includes: whether to support receiving based on the low power receiver and transmitting based on the main communication module simultaneously in a case that there isn't an overlap in frequency domain between the signal transmission based on the low power receiver and a signal transmission based on the main communication module.

It should be noted that if the terminal supports full duplex, the receiving based on the low power receiver and sending of the main communication module performed simultaneously is supported by default.

Optionally, the whether to support the transmission based on the low power receiver and the main communication module at the same frequency includes:
whether to support the transmission based on the low power receiver and the main communication module at the same frequency in a case that there isn't an overlap in time domain between a signal transmission based on the low power receiver and a signal transmission based on the main communication module.

Optionally, in some embodiments, in a case that the first information includes Tag feedback information, and sending of the Tag feedback information conflicts with sending of the second information, the terminal performs any one of the following: receiving the Tag feedback information or transmitting the second information. The Tag feedback information is backscatter transmission information.

For example, in backscatter communication in which the network side device performs continuous wave and/or backscatter control signaling receiving, and the terminal performs Tag feedback information receiving, that the terminal receives the Tag feedback information may conflict with at least one of the following types of second information:
(1) The terminal receives a downlink physical channel or a signal sent by the network side device; and
(2) The terminal sends an uplink physical channel or a signal.

In the above conflict, the behavior performed by the terminal may include any of the following:
(1) The terminal performs Tag feedback information receiving. This may ensure performance of backscatter communication; and
(2) The terminal performs second information transmission. This may ensure transmission performance of the second information.

Optionally, in some embodiments, in a case that the first information includes a continuous wave and/or backscatter control signaling, and sending of the first information conflicts with sending of the second information, the terminal performs any one of the following: sending the continuous wave and/or backscatter control signaling, or transmitting the second information. The backscatter transmission information includes the continuous wave and/or the backscatter control signaling.

For example, in backscatter communication in which the terminal performs continuous wave and/or backscatter control signaling sending, and the network side device performs Tag feedback information receiving, that the terminal sends the continuous wave and/or backscatter control signaling may conflict with at least one of the following types of second information:
(1) The terminal receives a downlink physical channel or a signal sent by the network side device; and
(2) The terminal sends an uplink physical channel or a signal.

In the above conflict, the behavior performed by the terminal may include any of the following:
(1) The terminal sends a continuous wave and/or backscatter control signaling. This may ensure performance of backscatter communication; and
(2) The terminal performs second information transmission. This may ensure transmission performance of the second information.

Optionally, in some embodiments, in a case that the first information includes a beacon signal, and the second information includes a synchronization signal and PBCH block, the performing, by a terminal, a target operation in a case that there is a conflict between transmission of first information and transmission of second information includes:
performing, by the terminal, measurement based on receiving of the synchronization signal and PBCH block in a case that there is a conflict between the measurement based on the beacon signal and the measurement based on the synchronization signal and PBCH block.

In this embodiment of this application, in a case that there is a conflict between measurement based on the beacon signal and measurement based on the synchronization signal and PBCH block, the measurement on the synchronization signal and PBCH block performed by the terminal can be more accurate than the measurement on the beacon signal, so that precision and accuracy of the measurement can be ensured, and reliability of communication can also be ensured.

It can be understood that in a case that there is a conflict between measurement based on beacon signal receiving and measurement based on synchronization signal and PBCH block receiving, the terminal performs measurement based on receiving of the synchronization signal and PBCH block.

In this embodiment of this application, the measurement based on the beacon signal may include mobility measurement based on the beacon signal. The measurement based on the synchronization signal and PBCH block may include at least one of RRM measurement and RLM measurement.

Optionally, that the terminal performs measurement based on receiving of the synchronization signal and PBCH block can be understood as: receiving the synchronization signal and PBCH block first, and then performing RRM measurement based on the received synchronization signal and PBCH block.

Optionally, in some embodiments, the performing, by the terminal, measurement based on receiving of the synchronization signal and PBCH block in a case that there is a conflict between the measurement based on the beacon signal and the measurement based on the synchronization signal and PBCH block includes:
performing, by the terminal, measurement based on the synchronization signal and PBCH block in the second time window in a case that there is a conflict between a first time window and a second time window, where
the first time window is a measurement time window of the beacon signal, and the second time window is a measurement time window of the synchronization signal and PBCH block.

Optionally, the measurement time window may also be referred to as monitoring duration of measurement.

Optionally, in some embodiments, the method further includes:
obtaining, by the terminal, configuration information, where the configuration information is used for configuring the measurement based on the beacon signal; and the configuration information includes at least one of the following:
a measurement cycle of the beacon signal;
a start offset of beacon signal measurement; and
monitoring duration of beacon signal measurement.

It should be noted that the measurement cycle of measuring the beacon signal is configured by the network side device, for example, configured through RRC signaling. Optionally, the measurement cycle of the beacon signal is greater than or equal to a beacon signal cycle. The beacon signal cycle is configured by the network side device or specified by a protocol. Further, the measurement cycle of the beacon signal is an integer multiple of the beacon signal cycle. The start offset of measurement of the beacon signal refers to a start time of the monitoring duration of measurement of the beacon signal (also referred to as a beacon signal measurement time window) relative to the beacon signal measurement cycle. The terminal performs beacon signal measurement within the monitoring duration of beacon signal measurement, and does not perform beacon signal measurement outside the monitoring duration of beacon signal measurement. Each beacon signal monitoring cycle corresponds to monitoring duration of beacon signal measurement.

Optionally, in a case that the first information includes a beacon signal, and the second information includes a synchronization signal and PBCH block, the performing, by a terminal, a target operation in a case that there is a conflict between transmission of first information and transmission of second information includes:
performing, by the terminal, measurement based on receiving of the synchronization signal and PBCH block, in a case that there is a conflict between receiving of a beacon signal not used for measurement and measurement based on the synchronization signal and PBCH block.

Optionally, receiving of a beacon signal not used for measurement may include: receiving of a beacon signal used for a synchronization or timing function. In addition, in another embodiment, receiving of a beacon signal not used for measurement can be understood as: receiving of a beacon signal outside the monitoring duration of beacon signal measurement.

Optionally, in some embodiments, in a case that the first information includes a wake up signal, and the second information includes a synchronization signal and PBCH block, the performing, by a terminal, a target operation in a case that there is a conflict between transmission of first information and transmission of second information includes:
performing, by the terminal, measurement based on receiving of the synchronization signal and PBCH block or receiving of the wake up signal, in a case that there is a conflict between receiving of the wake up signal and measurement based on receiving of the synchronization signal and PBCH block.

In an embodiment, the terminal performs, in a case that there is a conflict between receiving of the wake up signal and measurement based on receiving of the synchronization signal and PBCH block, measurement based on receiving of the synchronization signal and PBCH block. Therefore, measurement results related to link performance and communication quality can be obtained for the terminal to make a determination timely, that is, to determine timely whether to start neighbor cell measurement, perform cell reselection, or the like, which is conducive to improving the communication quality.

In another embodiment, the terminal performs receiving of the wake up signal in a case that there is a conflict between receiving of the wake up signal and measurement based on receiving of the synchronization signal and PBCH block. This can ensure that the terminal monitors the wake up signal in time, avoid the increase of wake up latency, and be beneficial to communication transmission efficiency.

Optionally, the target operation further includes not performing transmission of the first information and/or the second information within a target transition latency, where the target transition latency includes at least one of the following: the transition latency for the terminal to switch from the reception behavior based on the low power receiver to the transmission behavior based on the main communication module, and the transition latency for the terminal to switch from the transmission behavior based on the main communication module to the reception behavior based on the low power receiver.

For example, if the first information includes a wake up signal, the second information includes an SSB, and the measurement time window of the wake up signal includes a target transition latency, receiving of the SSB may not be performed within the target transition latency.

In an embodiment, the terminal neither receives the first information nor transmits the second information within the target transition latency.

It should be understood that measurement of the signal in this embodiment of this application can be understood as sensing or monitoring of the signal, for example, measurement of a wake up signal may be sensing or monitoring of the wake up signal.

The understanding of receiving in this embodiment of this application can be equivalent to monitoring.

Optionally, the first information includes a wake up signal, and the second information includes at least one of a semi-persistent scheduling (Semi-Persistent Scheduling, SPS) physical downlink shared channel (Physical Downlink Shared Channel, PDSCH), a first channel state information reference signal (CSI-RS), a physical uplink control channel (PUCCH), a configured grant (Configured Grant, CG) physical uplink shared channel (Physical Uplink Shared Channel, PUSCH), uplink control information (UCI), a butler status report (BSR), a scheduling request (SR), and a first sounding reference signal (SRS), where
the first CSI-RS is a periodic or semi-persistent CSI-RS, and the first SRS is a periodic or semi-persistent SRS.

Optionally, in some embodiments, the performing, by a terminal, a target operation in a case that there is a conflict between transmission of first information and transmission of second information includes at least one of the following:
receiving, by the terminal, the SPS PDSCH or the wake up signal in a case that there is a conflict between transmission of the wake up signal and transmission of the SPS PDSCH;
receiving, by the terminal, the wake up signal or the first CSI-RS in a case that there is a conflict between transmission of the wake up signal and transmission of the first CSI-RS;
sending, by the terminal, the PUCCH in a case that there is a conflict between transmission of the wake up signal and transmission of the PUCCH;
receiving, by the terminal, the wake up signal or sending the CG PUSCH in a case that there is a conflict between transmission of the wake up signal and transmission of the CG PUSCH;
sending, by the terminal, the UCI in a case that there is a conflict between transmission of the wake up signal and transmission of the UCI;
sending, by the terminal, the SR in a case that there is a conflict between transmission of the wake up signal and transmission of the SR;
sending, by the terminal, the BSR in a case that there is a conflict between transmission of the wake up signal and transmission of the BSR; and
in a case that there is a conflict between transmission of the wake up signal and transmission of the first SRS, the target operation includes receiving the wake up signal or sending the first SRS.

Optionally, the receiving the SPS PDSCH includes:
receiving, by the terminal, an SPS PDSCH after rate matching (rate-matching) or punching (puncture) the resources of the conflicting part.

Optionally, the receiving the wake up signal includes:
receiving, by the terminal, a wake up signal on which rate-matching (rate-matching) or puncture (puncture) is performed on a resource of a conflicting part.

That is, in this embodiment of this application, when a time-frequency domain resource occupied by the WUS conflicts with that occupied by the SPS PDSCH, if the SPS PDSCH is received, PDSCH receiving refers to a PDSCH on which rate-matching or puncture is performed on the wake up signal; and if the wake up signal is received, the wake up signal receiving refers to the wake up signal on which rate-matching or puncture is performed.

Optionally, in some embodiments, the first CSI-RS includes at least one of the following:
a CSI-RS used for RRM measurement or radio link monitoring (RLM) measurement;
a CSI-RS used for channel quality measurement; and
a CSI-RS used for channel interference measurement.

Optionally, in some embodiments, in a case that there is a conflict between transmission of the wake up signal and transmission of the PUCCH, and the PUCCH carries a scheduling request (SR), the target operation includes sending the SR.

It should be noted that, in this embodiment of this application, the information carried by the PUCCH may also include other information other than the SR, and other information may be or may not be transmitted, which is not further limited herein.

Optionally, in some embodiments, in a case that the CG PUSCH is repetitive type A PUSCH, repetitive type B PUSCH, or multi-slot PUSCH transmission, the sending the wake up signal includes: sending the wake up signal on a conflicting resource, and postponing sending the CG PUSCH. For example, after monitoring of the wake up signal is completed, the CG PUSCH is sent. Multi-slot PUSCH transmission can be understood as TB processing over multi-slot PUSCH (TB processing over multi-slot PUSCH, TboMS).

Optionally, in some embodiments, in a case that the CG PUSCH is repetitive type B PUSCH or multi-slot PUSCH transmission, the sending the wake up signal includes: sending the wake up signal on a conflicting resource, and sending the CG PUSCH in a splitting manner. For example, the CG PUSCH may be split with the granularity of slot. It is assumed that the CG PUSCH needs to be sent on three slot resources: slot 1, slot 2, and slot 3, and the wake up signal is monitored on two slots: slot 0 and slot 1. In this case, it may be determined that there is a conflict between the CG PUSCH and the wake up signal in slot 1, the CG PUSCH may be split, and CG PUSCH carrying information transmitted in slot 1 is split into any slot (such as slot 4) after slot 3 for transmission.

It should be understood that if sending of the CG PUSCH is postponed or split, the network side device needs to receive the CG PUSCH at a postponed or split location. That is, the network side device and the terminal need to agree on a corresponding postponement or splitting rule, and determine a time-frequency resource location occupied after the postponement or splitting.

Optionally, the performing, by a terminal, a target operation in a case that there is a conflict between transmission of first information and transmission of second information includes:
performing, by the terminal based on priorities of the first information and the second information, the target operation in a case that there is a conflict between transmission of the first information and transmission of the second information, where
the priorities of the first information and the second information are indicated by the network side device.

In this embodiment of this application, the network side device may indicate a transmission priority of the first information of the terminal in the above conflict cases (cases) through at least one of radio resource control (RRC) signaling, MAC control element (CE), and downlink control information (DCI). If it is indicated as a high priority, the first information is preferentially transmitted. If it is not indicated or indicated as a low priority, the terminal preferentially transmits the second information. For example, if the network side device has first information to transmit, transmission of the first information may conflict with transmission of second information. In this case, DCI may be used to indicate that the first information is of a high priority, to cancel (cancel) transmission of the second information that may conflict with transmission of the first information.

Optionally, in some embodiments, the performing, by a terminal, a target operation in a case that there is a conflict between transmission of first information and transmission of second information includes:
performing, by the terminal, a target operation on a conflicting resource in a case that there is a conflict between transmission of first information and transmission of second information.

Optionally, in some embodiments, the performing, by a terminal, a target operation in a case that there is a conflict between transmission of first information and transmission of second information includes:
performing, by the terminal, the target operation in a case that there is a conflict between transmission of the first information and transmission of the second information, and the terminal does not support transmission of the first information and the second information at the same time.

Optionally, in some embodiments, the conflict can also be avoided by the network side device. That is, it is realized by the network side device to avoid a conflict between signal receiving on the WUR and signal sending or receiving on the MR. In this case, for the terminal, the terminal does not expect to receive or send the second information when receiving the first information; or the terminal assumes that the network side device may not perform, when sending the first information, at least one of the following: sending the second information; and triggering the terminal to send the second information.

To better understand this application, some examples are used for detailed description below.

Optionally, in a case that the terminal does not support transmission of the WUR and the MR at the same time, the conflict case and behavior definition of the terminal are described in detail below.

In some embodiments, when the terminal is in an RRC idle (idle) state or an inactive (inactive) state, a possible conflict case and the behavior definition of the terminal are as follows.

First information received by the WUR in the idle state includes WUS and beacon. Second information received by the MR includes: SSB.
Conflict case 1: The terminal performs SSB measurement or beacon signal measurement in a case that there is a conflict between measurement based on the beacon signal and measurement based on the SSB.

Optionally, monitoring duration of the measurement based on the SSB is an SMTC monitoring window configured by the network side device, or monitoring duration of the measurement based on the SSB is a first measurement interval time window, where in the first measurement interval time window, the terminal performs, by using the MR, measurement based on the SSB instead of measurement based on the beacon signal.

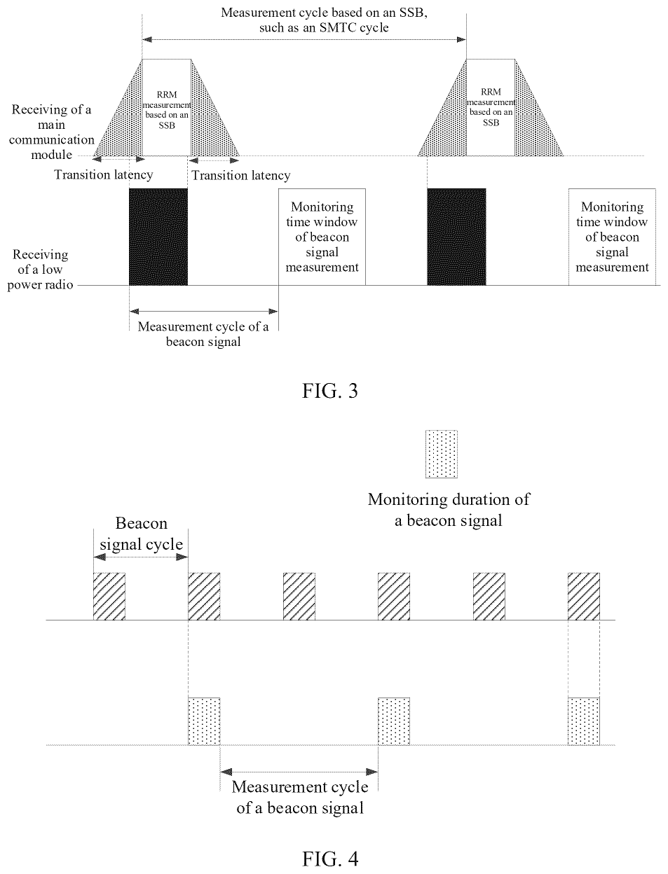

In an embodiment, as shown in FIG. 3, in a case that there is a conflict between measurement based on the beacon signal and measurement based on the SSB, the terminal performs SSB measurement. In addition, because there is a transition latency when the terminal switches from receiving the beacon signal based on the WUR to receiving the SSB based on the MR, as shown by a shaded triangle in the figure. If there is a conflict between measurement based on the beacon signal and the transition latency in time domain, the terminal may give up the conflicting measurement based on the beacon signal.

It can be understood that the measurement based on the beacon signal and the measurement based on the SSB need to be greater than or equal to a specific time interval in time domain.

Optionally, the measurement based on the SSB includes at least one of RRM measurement and RLM measurement.

Optionally, a measurement configuration based on the beacon signal obtained by the terminal includes at least one of the following:
a measurement cycle of the beacon signal;
a start offset of beacon signal measurement; and
monitoring duration of beacon signal measurement.

Optionally, the measurement cycle of the beacon signal is greater than or equal to a beacon signal cycle. Details are shown in FIG. 4.

It can be understood that in a case that there is a conflict between measurement based on the beacon signal and measurement based on the SSB, the terminal performs beacon signal measurement or SSB measurement, which can be understood as: in a case that there is a conflict between monitoring duration of beacon signal measurement and monitoring duration of SSB measurement, the terminal performs beacon signal measurement in the monitoring duration of beacon signal measurement, or performs SSB measurement in the monitoring duration of SSB measurement.

In this case, a conflict set includes:
Conflict 1-1: The beacon signal conflicts with the SSB in time domain but not in frequency domain;
further, a gap between the frequency domain in which the beacon signal is located and the frequency domain occupied by the SSB is greater than a specific value;
Conflict 1-2: The beacon signal does not conflict with the SSB in time domain but in frequency domain; and
Conflict 1-3: The beacon signal conflicts with the SSB in both time domain and frequency domain.

Further, a received power difference between the beacon signal and the SSB is less than a specific value.

A UE behavior set includes:
UE behavior 1-1: receiving the beacon signal; and
UE behavior 1-2: receiving the SSB.

It should be noted that any conflict case in the above conflict set can be combined with any UE behavior in the UE behavior set for implementation.
Conflict case 2: The terminal performs SSB measurement or measurement of the beacon signal not used for measurement in a case that there is a conflict between monitoring of the beacon signal not used for measurement and measurement based on the SSB.

In a case that there is a conflict between WUS monitoring and periodic or semi-persistent CSI-RS receiving, the terminal performs WUS monitoring or CSI-RS receiving.

The beacon signal not used for measurement can be understood as: receiving of a beacon signal outside the monitoring duration of beacon signal measurement.

In this case, a conflict set includes:
Conflict 2-1: The beacon signal not used for measurement conflicts with the SSB in time domain but not in frequency domain;
further, a gap between the frequency domain in which the beacon signal not used for measurement is located and the frequency domain occupied by the SSB is greater than a specific value;
Conflict 2-2: The beacon signal not used for measurement does not conflict with the SSB in time domain but in frequency domain; and
Conflict 2-3: The beacon signal not used for measurement conflicts with the SSB in both time domain and frequency domain.

Further, a received power difference between the beacon signal not used for measurement and the SSB is less than a specific value.

A UE behavior set includes:
UE behavior 2-1: receiving the beacon signal not used for measurement; and
UE behavior 2-2: receiving the SSB.

It should be noted that any conflict case in the above conflict set can be combined with any UE behavior in the UE behavior set for implementation.
Conflict case 3: The terminal performs SSB measurement or WUS monitoring in a case that there is a conflict between WUS monitoring and measurement based on the SSB.

In this case, a conflict set includes:
Conflict 3-1: The WUS conflicts with the SSB in time domain but not in frequency domain;
further, a gap between the frequency domain in which the WUS is located and the frequency domain occupied by the SSB is greater than a specific value;
Conflict 3-2: The WUS does not conflict with the SSB in time domain but in frequency domain; and
Conflict 3-3: The WUS conflicts with the SSB in both time domain and frequency domain.

Further, a received power difference between the WUS and the SSB is less than a specific value.

A UE behavior set includes:
UE behavior 3-1: receiving the WUS; and
UE behavior 3-2: receiving the SSB.

It should be noted that any conflict case in the above conflict set can be combined with any UE behavior in the UE behavior set for implementation.
Conflict case 4: The terminal does not perform receiving of the first information and the second information within a transition latency. The transition latency refers to a transition latency from WUR receiving to MR receiving.

It should be understood that in the above conflict cases, if the terminal is selected to perform SSB measurement, it will be beneficial to maintaining mobility measurement performance and link quality, thereby improving communication reliability.

In some embodiments, in an RRC connected (connected) state, possible conflict cases and behavior definition of the UE are as follows.
Conflict case 1: The terminal performs WUS monitoring or receives the SPS PDSCH in a case that WUS monitoring conflicts with receiving of the SPS PDSCH.

Optionally, if an SPS PDSCH occasion (occasion) is cancelled by a network indication, the terminal performs WUS monitoring.

When a time-frequency domain resource occupied by the WUS conflicts with that occupied by the SPS PDSCH, if the PDSCH is received, the PDSCH receiving is a resource occupied by a rate-matching or puncture WUS.
Conflict case 2: The terminal performs WUS monitoring or receives the first CSI-RS in a case that WUS monitoring conflicts with receiving of the first CSI-RS.

Optionally, the first CSI-RS includes receiving of a CSI-RS used for RRM or RLM measurement, and receiving of a CSI-RS used for channel quality measurement.

Optionally, in some embodiments, the UE is indicated to perform WUS monitoring in discontinuous reception (DRX) on duration (on duration). In this case, to monitor the WUS in the DRX on duration, the terminal preferentially determines to perform WUS monitoring, to learn of, as soon as possible, whether physical downlink control channel (PDCCH) monitoring needs to be resumed. When DRX is configured, the terminal does not need to perform mobility measurement based on the first CSI-RS outside the DRX on duration. Therefore, in another embodiment, if the UE is indicated to perform WUS monitoring outside a DRX activation time, the terminal preferentially performs WUS monitoring when WUS monitoring conflicts with measurement based on the first CSI-RS.
Conflict case 3: The terminal performs PUCCH carrying information sending or WUS monitoring in a case that there is a conflict between WUS monitoring and PUCCH sending.

Optionally, the PUCCH carrying information may include an SR. That is, the terminal sends the SR in a case that there is a conflict between WUS monitoring and SR sending.

Optionally, in a case that the terminal sends the SR, the terminal stops WUS monitoring and resumes PDCCH monitoring.
Conflict case 4: The terminal performs PUSCH sending or WUS monitoring in a case that there is a conflict between WUS monitoring and CG PUSCH sending.

Optionally, in a case that the CG PUSCH is repetitive type A PUSCH, repetitive type B PUSCH, or multi-slot PUSCH transmission, the terminal sends the wake up signal on a conflicting resource, and postpones sending the CG PUSCH.

Optionally, in a case that the CG PUSCH is repetitive type B PUSCH or multi-slot PUSCH transmission, the terminal sends the wake up signal on a conflicting resource, and sends the CG PUSCH in a splitting manner.
Conflict case 5: The terminal sends UCI or BSR in a case that there is a conflict between WUS monitoring and UCI or BSR sending.
Conflict case 6: The terminal performs WUS monitoring or sends the first SRS in a case that WUS monitoring conflicts with transmission of the first SRS.

Optionally, the first SRS is a periodic or semi-persistent SRS.

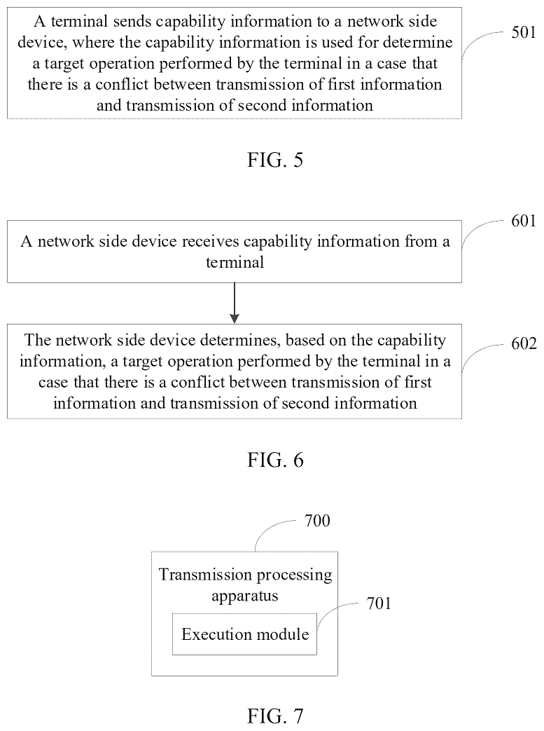

Referring to FIG. 5, an embodiment of this application further provides a transmission processing method. As shown in FIG. 5, the transmission processing method includes the following steps.
Step 501: A terminal sends capability information to a network side device, where the capability information is used for determine a target operation performed by the terminal in a case that there is a conflict between transmission of first information and transmission of second information.

The first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

Optionally, the whether to support the transmission based on a low power receiver and a main communication module at the same time includes at least one of the following:
whether to support receiving based on both the low power receiver and the main communication module simultaneously; and
whether to support receiving based on the low power receiver and transmitting based on the main communication module simultaneously.

Optionally, the whether to support receiving based on both the low power receiver and the main communication module simultaneously includes: whether to support receiving based on both the low power receiver and the main communication module simultaneously in a case that there isn't an overlap in frequency domain between the signal transmission based on the low power receiver and a signal transmission based on the main communication module; or
the whether to support receiving based on the low power receiver and transmitting based on the main communication module simultaneously includes: whether to support receiving based on the low power receiver and transmitting based on the main communication module simultaneously in a case that there isn't an overlap in frequency domain between the signal transmission based on the low power receiver and a signal transmission based on the main communication module.

Optionally, the whether to support the transmission based on the low power receiver and the main communication module at the same frequency includes:
whether to support the transmission based on the low power receiver and the main communication module at the same frequency in a case that there isn't an overlap in time domain between a signal transmission based on the low power receiver and a signal transmission based on the main communication module.

In this embodiment of this application, because the terminal reports the capability information to the network side device, the network side device may determine, based on the capability information, whether the terminal supports transmission of the WUR and the MR at the same time, and the network side device is assisted in determining a transmission behavior corresponding to the terminal when there is a conflict between the first information and the second information, to ensure that the terminal and the network side device have the same understanding of the terminal behavior after the conflict, and improve reliability of communication.

Referring to FIG. 6, an embodiment of this application further provides a transmission processing method. As shown in FIG. 6, the transmission processing method includes the following steps.
Step 601: A network side device receives capability information from a terminal.
Step 602: The network side device determines, based on the capability information, a target operation performed by the terminal in a case that there is a conflict between transmission of first information and transmission of second information.

The first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

Optionally, that there is a conflict between transmission of first information and transmission of second information includes at least one of the following:
at least partially overlaps between a time domain location of the first information and a time domain location of the second information;
at least partially overlaps between a frequency domain location of the first information and a frequency domain location of the second information;
at least partially overlaps between a resource occupied by the actually transmitted first information and a resource occupied by the actually transmitted second information;
at least partially overlaps between a transmission window of the first information and a transmission window of the second information;
at least partially overlaps between a transmission window of the actually transmitted first information and a transmission window of the actually transmitted second information;
a time interval between the time domain location of the first information and the time domain location of the second information is smaller than a first time interval; and
a frequency domain interval between the frequency domain location of the first information and the frequency domain location of the second information is smaller than a first frequency domain interval.

Optionally, the first time interval includes at least one of a first transition latency and a second transition latency, where
the first transition latency is a transition latency for the terminal to switch from a reception behavior based on a low power receiver to a transmission behavior based on a main communication module, and the second transition latency includes a transition latency for the terminal to switch from the transmission behavior based on the main communication module to the reception behavior based on the low power receiver.

Optionally, the whether to support the transmission based on a low power receiver and a main communication module at the same time includes at least one of the following:
whether to support receiving based on both the low power receiver and the main communication module simultaneously; and
whether to support receiving based on the low power receiver and transmitting based on the main communication module simultaneously.

Optionally, the whether to support receiving based on both the low power receiver and the main communication module simultaneously includes: whether to support receiving based on both the low power receiver and the main communication module simultaneously in a case that there isn't an overlap in frequency domain between the signal transmission based on the low power receiver and a signal transmission based on the main communication module; or
the whether to support receiving based on the low power receiver and transmitting based on the main communication module simultaneously includes: whether to support receiving based on the low power receiver and transmitting based on the main communication module simultaneously in a case that there isn't an overlap in frequency domain between the signal transmission based on the low power receiver and a signal transmission based on the main communication module.

Optionally, the whether to support the transmission based on the low power receiver and the main communication module at the same frequency includes:
whether to support the transmission based on the low power receiver and the main communication module at the same frequency in a case that there isn't an overlap in time domain between a signal transmission based on the low power receiver and a signal transmission based on the main communication module.

Optionally, the method further includes:
sending, by the network side device, configuration information to the terminal, where the configuration information is used for configuring measurement based on the beacon signal; and the configuration information includes at least one of the following:
a measurement cycle of the beacon signal;
a start offset of beacon signal measurement; and
monitoring duration of beacon signal measurement.

Optionally, the first information includes a wake up signal, and the second information includes at least one of a semi-persistent scheduling physical downlink shared channel (SPS PDSCH), a first channel state information reference signal (CSI-RS), a physical uplink control channel (PUCCH), a configured grant physical uplink shared channel (CG PUSCH), uplink control information (UCI), a butler status report (BSR), a scheduling request (SR), and a first sounding reference signal (SRS), where the first CSI-RS is a periodic or semi-persistent CSI-RS, and the first SRS is a periodic or semi-persistent SRS.

Optionally, after the determining, by the network side device based on the capability information, a target operation performed by the terminal in a case that there is a conflict between transmission of first information and transmission of second information, the method further includes:
in a case that there is a conflict between transmission of the wake up signal and transmission of the CG PUSCH, and the CG PUSCH is repetitive type A PUSCH, repetitive type B PUSCH, or multi-slot PUSCH transmission, sending, by the network side device, the wake up signal on a conflicting resource, and postponing receiving the CG PUSCH.

Optionally, after the determining, by the network side device based on the capability information, a target operation performed by the terminal in a case that there is a conflict between transmission of first information and transmission of second information, the method further includes:
in a case that there is a conflict between transmission of the wake up signal and transmission of the CG PUSCH, and the CG PUSCH is repetitive type B PUSCH or multi-slot PUSCH transmission, sending, by the network side device, the wake up signal on a conflicting resource, and receiving the CG PUSCH in a splitting manner.

The transmission processing method provided in this embodiment of this application may be executed by a transmission processing apparatus. In the embodiments of this application, the transmission processing apparatus according to an embodiment of this application is described by using an example in which the transmission processing apparatus performs the transmission processing method.

Referring to FIG. 7, an embodiment of this application further provides a transmission processing apparatus. As shown in FIG. 7, the transmission processing apparatus 700 includes:
an execution module 701, configured to perform a target operation in a case that there is a conflict between transmission of first information and transmission of second information, where
the first information includes at least one of a wake up signal, backscatter transmission information, and a beacon signal, the second information includes at least one of a physical channel and a signal, and the target operation includes any one of the following: transmitting the first information; and transmitting the second information.

Optionally, that there is a conflict between transmission of first information and transmission of second information includes at least one of the following:
at least partially overlaps between a time domain location of the first information and a time domain location of the second information;
at least partially overlaps between a frequency domain location of the first information and a frequency domain location of the second information;
at least partially overlaps between a resource occupied by the actually transmitted first information and a resource occupied by the actually transmitted second information;
at least partially overlaps between a transmission window of the first information and a transmission window of the second information;
at least partially overlaps between a transmission window of the actually transmitted first information and a transmission window of the actually transmitted second information;
a time interval between the time domain location of the first information and the time domain location of the second information is smaller than a first time interval; and a frequency domain interval between the frequency domain location of the first information and the frequency domain location of the second information is smaller than a first frequency domain interval.

Optionally, the first time interval includes at least one of a first transition latency and a second transition latency, where
the first transition latency is a transition latency for the terminal to switch from a reception behavior based on a low power receiver to a transmission behavior based on a main communication module, and the second transition latency includes a transition latency for the terminal to switch from the transmission behavior based on the main communication module to the reception behavior based on the low power receiver.

Optionally, the transmitting the first information by the terminal includes: receiving, by the terminal, the first information based on a low power receiver; and the transmitting the second information by the terminal includes: transmitting, by the terminal, the second information based on the main communication module.

Optionally, the transmission processing apparatus 700 further includes:
a second sending module, configured to send capability information to a network side device, where
the capability information includes at least one of the following:
whether to support the transmission based on a low power receiver and a main communication module at the same time; and
whether to support the transmission based on the low power receiver and the main communication module at the same frequency.

Optionally, the whether to support the transmission based on a low power receiver and a main communication module at the same time includes at least one of the following:
whether to support receiving based on both the low power receiver and the main communication module simultaneously; and
whether to support receiving based on the low power receiver and transmitting based on the main communication module simultaneously.

Optionally, the whether to support receiving based on both the low power receiver and the main communication module simultaneously includes: whether to support receiving based on both the low power receiver and the main communication module simultaneously in a case that there isn't an overlap in frequency domain between the signal transmission based on the low power receiver and a signal transmission based on the main communication module; or
the whether to support receiving based on the low power receiver and transmitting based on the main communication module simultaneously includes: whether to support receiving based on the low power receiver and transmitting based on the main communication module simultaneously in a case that there isn't an overlap in frequency domain between the signal transmission based on the low power receiver and a signal transmission based on the main communication module.

Optionally, the whether to support the transmission based on the low power receiver and the main communication module at the same frequency includes:
whether to support the transmission based on the low power receiver and the main communication module at the same frequency in a case that there isn't an overlap in time domain between a signal transmission based on the low power receiver and a signal transmission based on the main communication module.

Optionally, in a case that the first information includes a beacon signal, and the second information includes a synchronization signal and PBCH block, the execution module 701 is specifically configured to perform, in a case that there is a conflict between measurement based on the beacon signal and measurement based on the synchronization signal and PBCH block, measurement based on receiving of the synchronization signal and PBCH block.

Optionally, the execution module 701 is specifically configured to:
perform measurement based on the synchronization signal and PBCH block in a case that there is a conflict between a first time window and a second time window, where
the first time window is a measurement time window of the beacon signal, and the second time window is a measurement time window of the synchronization signal and PBCH block.

Optionally, the transmission processing apparatus 700 further includes:
an obtaining module, configured to obtain configuration information, where the configuration information is used for configuring the measurement based on the beacon signal; and the configuration information includes at least one of the following:
a measurement cycle of the beacon signal;
a start offset of beacon signal measurement; and
monitoring duration of beacon signal measurement.

Optionally, in a case that the first information includes a beacon signal, and the second information includes a synchronization signal and PBCH block, the execution module 701 is specifically configured to perform, in a case that there is a conflict between receiving of a beacon signal not used for measurement and measurement based on the synchronization signal and PBCH block, measurement based on receiving of the synchronization signal and PBCH block.

Optionally, in a case that the first information includes a wake up signal, and the second information includes a synchronization signal and PBCH block, the execution module 701 is specifically configured to perform, in a case that there is a conflict between receiving of the wake up signal and measurement based on receiving of the synchronization signal and PBCH block, measurement or receiving of the wake up signal based on receiving of the synchronization signal and PBCH block.

Optionally, the target operation further includes not performing transmission of the first information and/or the second information within a target transition latency, where the target transition latency includes at least one of the following: the transition latency for the terminal to switch from the reception behavior based on the low power receiver to the transmission behavior based on the main communication module, and the transition latency for the terminal to switch from the transmission behavior based on the main communication module to the reception behavior based on the low power receiver.

Optionally, the first information includes a wake up signal, and the second information includes at least one of a semi-persistent scheduling physical downlink shared channel (SPS PDSCH), a first channel state information reference signal (CSI-RS), a physical uplink control channel (PUCCH), a configured grant physical uplink shared channel (CG PUSCH), uplink control information (UCI), a butler status report (BSR), a scheduling request (SR), and a first sounding reference signal (SRS), where the first CSI-RS is a periodic or semi-persistent CSI-RS, and the first SRS is a periodic or semi-persistent SRS.

Optionally, the execution module 701 is configured to perform at least one of the following:
receiving the SPS PDSCH or the wake up signal in a case that there is a conflict between transmission of the wake up signal and transmission of the SPS PDSCH;
receiving the wake up signal or the first CSI-RS in a case that there is a conflict between transmission of the wake up signal and transmission of the first CSI-RS;
sending the PUCCH in a case that there is a conflict between transmission of the wake up signal and transmission of the PUCCH;
receiving the wake up signal or sending the CG PUSCH in a case that there is a conflict between transmission of the wake up signal and transmission of the CG PUSCH;
sending the UCI in a case that there is a conflict between transmission of the wake up signal and transmission of the UCI;
sending the SR in a case that there is a conflict between transmission of the wake up signal and transmission of the SR;
sending the BSR in a case that there is a conflict between transmission of the wake up signal and transmission of the BSR; and
receiving the wake up signal or sending the first SRS in a case that there is a conflict between transmission of the wake up signal and transmission of the first SRS.

Optionally, the execution module 701 is configured to receive an SPS PDSCH after rate matching or punching the resources of the conflicting part.

Optionally, the first CSI-RS includes at least one of the following:
a CSI-RS used for RRM measurement or radio link monitoring (RLM) measurement; and
a CSI-RS used for channel quality measurement.

Optionally, in a case that there is a conflict between transmission of the wake up signal and transmission of the PUCCH, and the PUCCH carries a scheduling request (SR), the target operation includes sending the SR.

Optionally, in a case that the CG PUSCH is repetitive type A PUSCH, repetitive type B PUSCH, or multi-slot PUSCH transmission, the sending the wake up signal includes: sending the wake up signal on a conflicting resource, and postponing sending the CG PUSCH.

Optionally, in a case that the CG PUSCH is repetitive type B PUSCH or multi-slot PUSCH transmission, the sending the wake up signal includes: sending the wake up signal on a conflicting resource, and sending the CG PUSCH in a splitting manner.

Optionally, the execution module 701 is specifically configured to:
perform, based on priorities of the first information and the second information, the target operation in a case that there is a conflict between transmission of the first information and transmission of the second information, where
the priorities of the first information and the second information are indicated by the network side device.

Optionally, the execution module 701 is specifically configured to:
perform a target operation on a conflicting resource in a case that there is a conflict between transmission of first information and transmission of second information.

Optionally, the execution module 701 is specifically configured to:
perform the target operation in a case that there is a conflict between transmission of the first information and transmission of the second information, and the terminal does not support transmission of the first information and the second information at the same time.

Referring to FIG. 8, an embodiment of this application further provides a transmission processing apparatus. As shown in FIG. 8, the transmission processing apparatus 800 includes:
a first sending module 801, configured to send capability information to a network side device, where the capability information is used for determine a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

Optionally, the whether to support the transmission based on a low power receiver and a main communication module at the same time includes at least one of the following:
whether to support receiving based on both the low power receiver and the main communication module simultaneously; and
whether to support receiving based on the low power receiver and transmitting based on the main communication module simultaneously.

Optionally, the whether to support receiving based on both the low power receiver and the main communication module simultaneously includes: whether to support receiving based on both the low power receiver and the main communication module simultaneously in a case that there isn't an overlap in frequency domain between the signal transmission based on the low power receiver and a signal transmission based on the main communication module; or
the whether to support receiving based on the low power receiver and transmitting based on the main communication module simultaneously includes: whether to support receiving based on the low power receiver and transmitting based on the main communication module simultaneously in a case that there isn't an overlap in frequency domain between the signal transmission based on the low power receiver and a signal transmission based on the main communication module.

Optionally, the whether to support the transmission based on the low power receiver and the main communication module at the same frequency includes:
whether to support the transmission based on the low power receiver and the main communication module at the same frequency in a case that there isn't an overlap in time domain between a signal transmission based on the low power receiver and a signal transmission based on the main communication module.

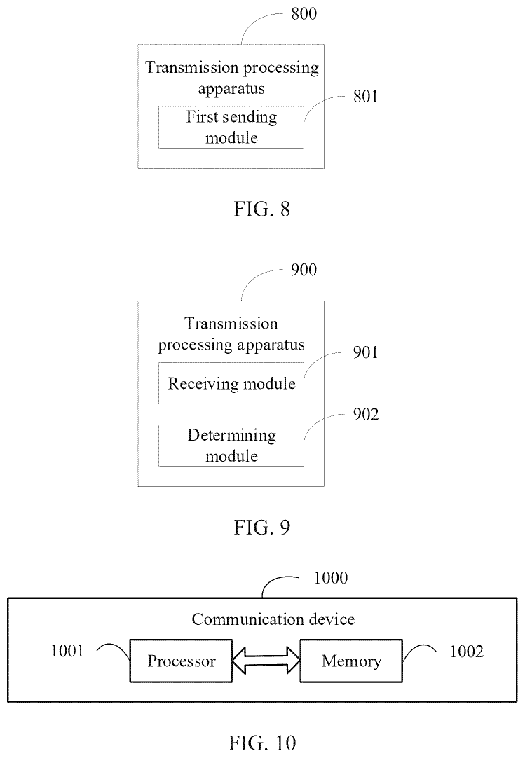

Referring to FIG. 9, an embodiment of this application further provides a transmission processing apparatus. As shown in FIG. 9, the transmission processing apparatus 900 includes:
a receiving module 901, configured to receive capability information from a terminal; and
a determining module 902, configured to determine, based on the capability information, a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

Optionally, that there is a conflict between transmission of first information and transmission of second information includes at least one of the following:
at least partially overlaps between a time domain location of the first information and a time domain location of the second information;
at least partially overlaps between a frequency domain location of the first information and a frequency domain location of the second information;
at least partially overlaps between a resource occupied by the actually transmitted first information and a resource occupied by the actually transmitted second information;
at least partially overlaps between a transmission window of the first information and a transmission window of the second information;
at least partially overlaps between a transmission window of the actually transmitted first information and a transmission window of the actually transmitted second information;
a time interval between the time domain location of the first information and the time domain location of the second information is smaller than a first time interval; and
a frequency domain interval between the frequency domain location of the first information and the frequency domain location of the second information is smaller than a first frequency domain interval.

Optionally, the first time interval includes at least one of a first transition latency and a second transition latency, where
the first transition latency is a transition latency for the terminal to switch from a reception behavior based on a low power receiver to a transmission behavior based on a main communication module, and the second transition latency includes a transition latency for the terminal to switch from the transmission behavior based on the main communication module to the reception behavior based on the low power receiver.

Optionally, the whether to support the transmission based on a low power receiver and a main communication module at the same time includes at least one of the following:
whether to support receiving based on both the low power receiver and the main communication module simultaneously; and
whether to support receiving based on the low power receiver and transmitting based on the main communication module simultaneously.

Optionally, the whether to support receiving based on both the low power receiver and the main communication module simultaneously includes: whether to support receiving based on both the low power receiver and the main communication module simultaneously in a case that there isn't an overlap in frequency domain between the signal transmission based on the low power receiver and a signal transmission based on the main communication module; or
the whether to support receiving based on the low power receiver and transmitting based on the main communication module simultaneously includes: whether to support receiving based on the low power receiver and transmitting based on the main communication module simultaneously in a case that there isn't an overlap in frequency domain between the signal transmission based on the low power receiver and a signal transmission based on the main communication module.

Optionally, the whether to support the transmission based on the low power receiver and the main communication module at the same frequency includes:
whether to support the transmission based on the low power receiver and the main communication module at the same frequency in a case that there isn't an overlap in time domain between a signal transmission based on the low power receiver and a signal transmission based on the main communication module.

Optionally, the transmission processing apparatus further includes:
a third sending module, configured to send configuration information to the terminal, where the configuration information is used for configuring measurement based on the beacon signal; and the configuration information includes at least one of the following:
a measurement cycle of the beacon signal;
a start offset of beacon signal measurement; and
monitoring duration of beacon signal measurement.

Optionally, the first information includes a wake up signal, and the second information includes at least one of a semi-persistent scheduling physical downlink shared channel (SPS PDSCH), a first channel state information reference signal (CSI-RS), a physical uplink control channel (PUCCH), a configured grant physical uplink shared channel (CG PUSCH), uplink control information (UCI), a butler status report (BSR), a scheduling request (SR), and a first sounding reference signal (SRS), where
the first CSI-RS is a periodic or semi-persistent CSI-RS, and the first SRS is a periodic or semi-persistent SRS.

Optionally, the transmission processing apparatus 900 further includes a third sending module; and
the third sending module and the receiving module 901 are configured to: in a case that there is a conflict between transmission of the wake up signal and transmission of the CG PUSCH, and the CG PUSCH is repetitive type A PUSCH, repetitive type B PUSCH, or multi-slot PUSCH transmission, send the wake up signal on a conflicting resource, and postpone receiving the CG PUSCH.

Optionally, the transmission processing apparatus 900 further includes a third sending module; and
the third sending module and the receiving module 901 are configured to: in a case that there is a conflict between transmission of the wake up signal and transmission of the CG PUSCH, and the CG PUSCH is repetitive type B PUSCH or multi-slot PUSCH transmission, send the wake up signal on a conflicting resource, and receive the CG PUSCH in a splitting manner.

The transmission processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a network attached storage (Network Attached Storage, NAS), and the like. This is not specifically limited in this embodiment of this application.

The transmission processing apparatus provided in the embodiments of this application can implement the processes implemented in the method embodiments in FIG. 2 to FIG. 6, and a same technical effect can be achieved. To avoid repetition, details are not described herein again.

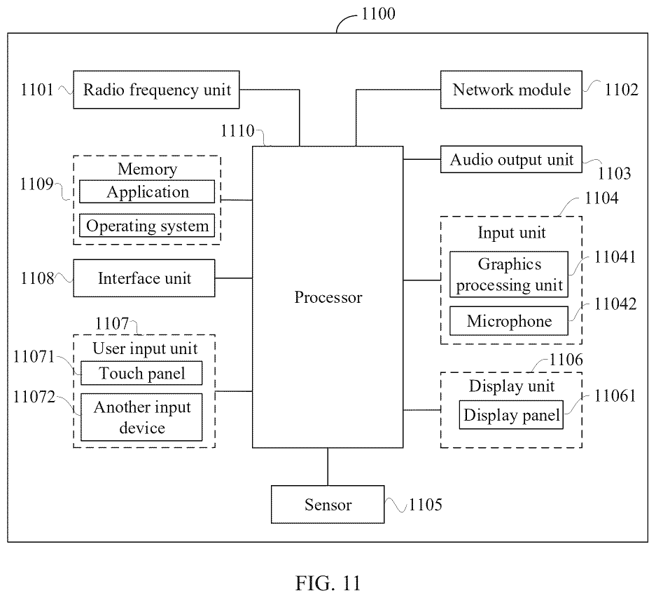

Optionally, as shown in FIG. 10, an embodiment of this application further provides a communication device 1000, including a processor 1001 and a memory 1002, and the memory 1002 stores a program or an instruction that can be run on the processor 1001. When the program or the instruction is executed by the processor 1001, the steps of the transmission processing method embodiment are implemented, and a same technical effect can be achieved. To avoid repetition, details are not described herein again.

An embodiment of this application further provides a terminal, including a processor and a communication interface, where
the communication interface is configured to perform a target operation in a case that there is a conflict between transmission of first information and transmission of second information, where the first information includes at least one of a wake up signal, backscatter transmission information, and a beacon signal, the second information includes at least one of a physical channel and a signal, and the target operation includes any one of the following: transmitting the first information; and transmitting the second information; or
the communication interface is configured to send capability information to a network side device, where the capability information is used for determine a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

The terminal embodiment is corresponding to the method embodiment on the terminal side, each implementation process and implementation of the method embodiment can be applied to the terminal embodiment, and a same technical effect can be achieved. Specifically, FIG. 11 is a schematic diagram of a hardware structure of a terminal according to an embodiment of this application.

The terminal 1100 includes but is not limited to: at least some of the following components: a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art may understand that the terminal 1100 may further include a power supply (such as a battery) that supplies power to each component. The power supply may be logically connected to the processor 1110 through a power management system, to implement functions such as charging and discharging management, and power consumption management by using the power management system. The terminal structure shown in FIG. 11 constitutes no limitation on the terminal, and the terminal may include more or fewer components than those shown in the figure, or combine some components, or have different component arrangements. Details are not described herein again.

It should be understood that, in this embodiment of this application, the input unit 1104 may include a graphics processing unit (GPU) 11041 and a microphone 11042, and the graphics processing unit 11041 processes image data of a still picture or a video obtained by an image capture apparatus (such as a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein again.

In this embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or instructions and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1109 in this embodiment of this application includes but is not limited to these memories and any memory of another proper type.

The processor 1110 may include one or more processing units. Optionally, an application processor and a modem processor are integrated into the processor 1110. The application processor mainly processes an operating system, a user interface, an application, and the like. The modem processor mainly processes a wireless communication signal, for example, a baseband processor. It may be understood that, alternatively, the modem processor may not be integrated into the processor 1110.

The radio frequency unit 1101 is configured to perform a target operation in a case that there is a conflict between transmission of first information and transmission of second information, where the first information includes at least one of a wake up signal, backscatter transmission information, and a beacon signal, the second information includes at least one of a physical channel and a signal, and the target operation includes any one of the following: transmitting the first information; and transmitting the second information; or
the radio frequency unit 1101 is configured to send capability information to a network side device, where the capability information is used for determine a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

An embodiment of this application further provides a network side device, including a processor and a communication interface. The communication interface is configured to receive capability information from a terminal; and the processor is configured to determine, based on the capability information, a target operation performed by the terminal in a case that there is a conflict between transmission of first information and transmission of second information, where
the first information includes at least one of a wake up signal, backscatter transmission information, and a beacon signal, the second information includes at least one of a physical channel and a signal, the target operation includes at least one of transmitting the first information and transmitting the second information, and the capability information includes at least one of the following:
whether to support the transmission based on a low power receiver and a main communication module at the same time; and
whether to support the transmission based on the low power receiver and the main communication module at the same frequency.

This network side device embodiment is corresponding to the foregoing method embodiment of the network side device. Each implementation process and implementation of the foregoing method embodiment may be applicable to this network side device embodiment, and a same technical effect can be achieved.

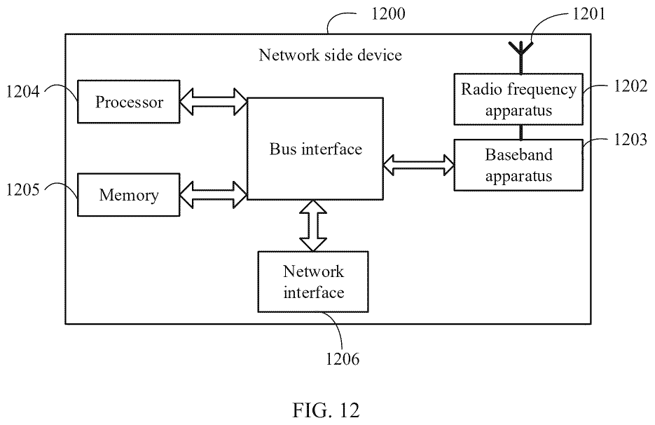

Specifically, an embodiment of this application further provides a network side device. As shown in FIG. 12, the network side device 1200 includes an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information by using the antenna 1201, and sends the received information to the baseband apparatus 1203 for processing. In a downlink direction, the baseband apparatus 1203 processes to-be-sent information, and sends the to-be-sent information to the radio frequency apparatus 1202. After processing the received information, the radio frequency apparatus 1202 sends the information through the antenna 1201.

In the foregoing embodiment, the method performed by the network side device may be implemented in a baseband apparatus 1203. The baseband apparatus 1203 includes a baseband processor.

For example, the baseband apparatus 1203 may include at least one baseband board. A plurality of chips are disposed on the baseband board. As shown in FIG. 12, one chip is, for example, a baseband processor, and is connected to the memory 1205 by using a bus interface, to invoke a program in the memory 1205 to perform the operations of the network device shown in the foregoing method embodiment.

The network side device may further include a network interface 1206. The interface is, for example, a common public radio interface (common public radio interface, CPRI).

Specifically, the network side device 1200 in this embodiment of this application further includes an instruction or a program that is stored in the memory 1205 and that can be run on the processor 1204. The processor 1204 invokes the instruction or the program in the memory 1205 to perform the method performed by the modules shown in FIG. 7, and a same technical effect is achieved. To avoid repetition, details are not described herein again.

An embodiment of this application further provides a readable storage medium. The readable storage medium stores a program or an instruction. When the program or the instruction is executed by a processor, the processes in the foregoing transmission processing method embodiments are implemented, with the same technical effects achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc.

An embodiment of this application still provides a chip. The chip includes a processor and a communication interface, and the communication interface is coupled to the processor. The processor is configured to run a program or an instruction, to implement various processes of the foregoing embodiments of the transmission processing method, and a same technical effect can be achieved. To avoid repetition, details are not described herein again.

It should be understood that the chip mentioned in this embodiment of this application may also be referred to as a system-level chip, a system chip, a chip system, an on-chip system chip, or the like.

An embodiment of this application further provides a computer program/program product. The computer program/program product is stored in a storage medium, the computer program/program product is executed by at least one processor to implement the processes of the foregoing transmission processing method embodiment, and a same technical effect can be achieved. To avoid repetition, details are not described herein again.

An embodiment of this application further provides a communication system, including a terminal and a network side device. The terminal is configured to execute the processes of the foregoing method embodiments in FIG. 2 or FIG. 5 and on the terminal side, the network side device is configured to execute the processes of the foregoing method embodiments in FIG. 6 and on the network side device, and a same technical effect can be achieved. To avoid repetition, details are not described herein again.

It should be noted that in this specification, the term “include”, “comprise”, or any other variant is intended to cover non-exclusive inclusion, so that a process, method, article, or apparatus that includes a series of elements includes not only those elements but also other elements that are not explicitly listed, or includes elements inherent to such a process, method, article, or apparatus. In the absence of more restrictions, an element defined by the statement “including a . . . ” does not preclude the presence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (such as a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A transmission processing method, comprising:
performing, by a terminal, a target operation in a case that there is a conflict between transmission of first information and transmission of second information, wherein
the first information comprises a wake up signal, the second information comprises at least one of a physical channel and a signal, and the target operation comprises transmitting the second information without transmitting a part of the first information whose transmission conflicts with the transmission of the second information.

2. The method according to claim 1, wherein the conflict between transmission of first information and transmission of second information comprises at least one of the following:
at least partially overlaps between a time domain location of the first information and a time domain location of the second information;
at least partially overlaps between a frequency domain location of the first information and a frequency domain location of the second information;
at least partially overlaps between a resource occupied by the actually transmitted first information and a resource occupied by the actually transmitted second information;
at least partially overlaps between a transmission window of the first information and a transmission window of the second information;
at least partially overlaps between a transmission window of the actually transmitted first information and a transmission window of the actually transmitted second information;
a time interval between the time domain location of the first information and the time domain location of the second information is smaller than a first time interval; or
a frequency domain interval between the frequency domain location of the first information and the frequency domain location of the second information is smaller than a first frequency domain interval.

3. The method according to claim 2, wherein the first time interval comprises at least one of a first transition latency and a second transition latency, wherein
the first transition latency is a transition latency for the terminal to switch from a reception behavior based on a low power receiver to a transmission behavior based on a main communication module, and the second transition latency comprises a transition latency for the terminal to switch from the transmission behavior based on the main communication module to the reception behavior based on the low power receiver.

4. The method according to claim 1, further comprising: receiving, by the terminal, the first information based on a low power receiver,
wherein the transmitting the second information by the terminal comprises: transmitting, by the terminal, the second information based on the main communication module.

5. The method according to claim 4, wherein before the performing, by a terminal, a target operation when there is a conflict between transmission of first information and transmission of second information, the method further comprises:
sending, by the terminal, capability information to a network side device, wherein
the capability information comprises at least one of the following:
whether to support the transmission based on a low power receiver and a main communication module at the same time; or
whether to support the transmission based on the low power receiver and the main communication module at the same frequency.

6. The method according to claim 5, wherein the whether to support the transmission based on a low power receiver and a main communication module at the same time comprises at least one of the following:
whether to support receiving based on both the low power receiver and the main communication module simultaneously; and
whether to support receiving based on the low power receiver and transmitting based on the main communication module simultaneously.

7. The method according to claim 5, wherein the whether to support receiving based on both the low power receiver and the main communication module simultaneously comprises: whether to support receiving based on both the low power receiver and the main communication module simultaneously when there is no overlap in frequency domain between the signal transmission based on the low power receiver and a signal transmission based on the main communication module; or
the whether to support receiving based on the low power receiver and transmitting based on the main communication module simultaneously comprises: whether to support receiving based on the low power receiver and transmitting based on the main communication module simultaneously when there is no overlap in frequency domain between the signal reception based on the low power receiver and a signal reception based on the main communication module.

8. The method according to claim 5, wherein the whether to support the transmission based on the low power receiver and the main communication module at the same frequency comprises:
whether to support the transmission based on the low power receiver and the main communication module at the same frequency when there is no overlap in time domain between a signal transmission based on the low power receiver and a signal transmission based on the main communication module.

9. The method according to claim 1, wherein when the second information comprises a synchronization signal and PBCH block, the performing, by a terminal, a target operation when there is a conflict between transmission of first information and transmission of second information comprises:
performing, by the terminal, measurement based on receiving of the synchronization signal and PBCH block or receiving of the wake up signal, when there is a conflict between receiving of the wake up signal and measurement based on receiving of the synchronization signal and PBCH block.

10. The method according to claim 1, wherein the first information comprises a wake up signal, and the second information comprises at least one of a semi-persistent scheduling physical downlink shared channel (SPS PDSCH), a first channel state information reference signal (CSI-RS), a physical uplink control channel (PUCCH), a configured grant physical uplink shared channel (CG PUSCH), uplink control information (UCI), a butler status report (BSR), a scheduling request (SR), or a first sounding reference signal (SRS), wherein
the first CSI-RS is a periodic or semi-persistent CSI-RS, and the first SRS is a periodic or semi-persistent SRS.

11. The method according to claim 1, wherein the performing, by a terminal, a target operation when there is a conflict between transmission of first information and transmission of second information comprises:
performing, by the terminal, the target operation when there is a conflict between transmission of the first information and transmission of the second information, and the terminal does not support transmission of the first information and the second information at the same time.

12. A transmission processing method, comprising:
sending, by a terminal, capability information to a network side device, wherein the capability information is used for determine a target operation performed by the terminal when there is a conflict between transmission of first information and transmission of second information, wherein
the first information comprises at least one of a wake up signal, the second information comprises at least one of a physical channel and a signal, the target operation comprises transmitting the second information without transmitting a part of the first information whose transmission conflicts with the transmission of the second information, and the capability information comprises at least one of the following:
whether to support the transmission based on a low power receiver and a main communication module at the same time; or
whether to support the transmission based on the low power receiver and the main communication module at the same frequency.

13. The method according to claim 12, wherein the whether to support the transmission based on a low power receiver and a main communication module at the same time comprises at least one of the following:
whether to support receiving based on both the low power receiver and the main communication module simultaneously; and
whether to support receiving based on the low power receiver and transmitting based on the main communication module simultaneously.

14. The method according to claim 13, wherein the whether to support receiving based on both the low power receiver and the main communication module simultaneously comprises: whether to support receiving based on both the low power receiver and the main communication module simultaneously when there is no overlap in frequency domain between the signal transmission based on the low power receiver and a signal transmission based on the main communication module; or
the whether to support receiving based on the low power receiver and transmitting based on the main communication module simultaneously comprises: whether to support receiving based on the low power receiver and transmitting based on the main communication module simultaneously when there is no overlap in frequency domain between the signal transmission based on the low power receiver and a signal transmission based on the main communication module.

15. The method according to claim 12, wherein the whether to support the transmission based on the low power receiver and the main communication module at the same frequency comprises:
whether to support the transmission based on the low power receiver and the main communication module at the same frequency when there is no overlap in time domain between a signal transmission based on the low power receiver and a signal transmission based on the main communication module.

16. A terminal, comprising a processor and a memory, wherein the memory stores a program or instructions that, when executed by the processor, perform a transmission processing method, comprising:
performing a target operation when there is a conflict between transmission of first information and transmission of second information, wherein
the first information comprises a wake up signal, the second information comprises at least one of a physical channel and a signal, and the target operation comprises transmitting the second information without transmitting a part of the first information whose transmission conflicts with the transmission of the second information.

17. The terminal according to claim 16, wherein the conflict between transmission of first information and transmission of second information comprises at least one of the following:
at least partially overlaps between a time domain location of the first information and a time domain location of the second information;
at least partially overlaps between a frequency domain location of the first information and a frequency domain location of the second information;
at least partially overlaps between a resource occupied by the actually transmitted first information and a resource occupied by the actually transmitted second information;
at least partially overlaps between a transmission window of the first information and a transmission window of the second information;
at least partially overlaps between a transmission window of the actually transmitted first information and a transmission window of the actually transmitted second information;
a time interval between the time domain location of the first information and the time domain location of the second information is smaller than a first time interval; or
a frequency domain interval between the frequency domain location of the first information and the frequency domain location of the second information is smaller than a first frequency domain interval.

18. The terminal according to claim 16, wherein the transmission processing method further comprises: receiving the first information based on a low power receiver; and
wherein the transmitting the second information comprises: transmitting the second information based on the main communication module.

19. The terminal according to claim 16, wherein when the second information comprises a synchronization signal and PBCH block, the performing a target operation when there is a conflict between transmission of first information and transmission of second information comprises:
performing measurement based on receiving of the synchronization signal and PBCH block or receiving of the wake up signal, when there is a conflict between receiving of the wake up signal and measurement based on receiving of the synchronization signal and PBCH block.

20. The terminal according to claim 16, wherein the performing a target operation when there is a conflict between transmission of first information and transmission of second information comprises:
performing the target operation when there is a conflict between transmission of the first information and transmission of the second information, and the terminal does not support transmission of the first information and the second information at the same time.
